(19) United States
(12) Patent Application Publication
(10) Pub. No.: US 2005/0177328 A1
(43) Pub. Date: Aug. 11, 2005

(54) Process for the electromagnetic modelling of electronic components and systems

(76) Inventors: Piero Belforte, Torino (IT); Giovanni Ghigo, Torino (IT); Flavio Maggioni, Torino (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/297,634

(22) PCT Filed: May 31, 2001
(86) PCT No.: PCT/EP01/06176

(30) Foreign Application Priority Data
Jun. 5, 2000 (IT) TO 2000A000527

(51) Int. Cl. G06F 19/00

(52) U.S. Cl. 702/65

(57) ABSTRACT

Process for the electromagnetic modelling of electronic components and systems, for the extraction of certain electrical parameters, such as the static V-I characteristics and the input and output impedance, the output switching times in particular conditions of load and the transition times of the protection diodes. A test machine of the commercial type is used for these measurements, by generating stimulus signals and measuring the correlated signals, the test machine being suitable for parametric direct current measurements, functional tests and digital integrated circuit timing and also being used as a time domain reflectometer. The measurement phase is followed by a simulation phase during which the electric parameters used for modelling electronic components and systems are extracted.

This invention relates to measurement methods for evaluating electromagnetic compatibility, and particularly relates to a process for the electromagnetic modelling of electronic components and systems.

With the increased level of integration and operating frequency of electronic components and systems, the need to check the electromagnetic compatibility between different parts of any one system, or between different systems in conditions of mutual interference, and the integrity of signals exchanged in electronic systems between the various components is becoming increasingly important.

The integrity of signals is particularly important in digital systems, where the treated signals are essentially binary signals. For the good operation of systems, these signals must satisfy certain minimum quality requirements. Particularly, two voltage levels, corresponding to bit 1 and 0, and the transition times between the levels must be preserved. Furthermore, interference between adjacent conductors, skin effect attenuation and spurious signals originated from reflection of the original signals in the presence of discontinuous impedance must be minimised.

In digital systems, the increase in signal switching front steepness and dock frequency increases the intensity of the electromagnetic field radiated by the various component parts, such as conductors and active and passive components, with the consequent possibility of exceeding the limits established in the emission standard. As a consequence, the device may not be type-approved or, consequently, marketed.

These problems can be obviated by an accurate system design, which accounts for the electromagnetic performance of the various components employed. The validity of design can be verified before system construction by exploiting the possibilities offered by simulation programs readily available on the market. Electromagnetic compatibility data, which can be provided by such programs, will be closer to reality the more the component and system models employed for describing the entire device to be simulated are accurate.

Standard model definition processes have existed for several years. These processes guide technicians in identifying the parameters of the model and describing the model Of such processes, the most common is that proposed by the IBIS (Input-output Buffer Information Specification) Association, which consists in describing the static V-I characteristics of all component inputs and outputs, the output transition times in particular conditions of load, the parasite parameters associated to all inputs and outputs, such as the capacitance with respect to a reference potential, and other parameters.

At this time, there are not many available electronic component models. The few available models essentially refer to integrated circuits and are widely incomplete and not very accurate. These models are obtained by simulation employing known methods (SPICE), using technological parameters, in some cases provided by the manufacturers, or by using the scarce information provided by component data sheets. In other cases, the models are made by means of measurements using single instruments, with considerable waste of time for preparing the bench and for making settings and measurements.

The process illustrated in this invention obviates these disadvantages and solves the technical problem described above by allowing automatic electronic component and system modelling using normal electronic test machines in an original way, without requiring costly modifications. All access points of the device under test can be characterised rapidly also when dealing with very complex stimulation signals. The test machine can be used in a conventional way for conducting functional tests or, according to this invention, for modelling in the same test session, without the need for additional manual interventions on behalf of the operator.

Specifically, object of this invention is a process for the electromagnetic modelling of electronic components and systems the characteristics of which are described in claim 1.

This invention will be better explained by the following detailed description with reference to the accompanying drawings as non-limiting example, wherein:

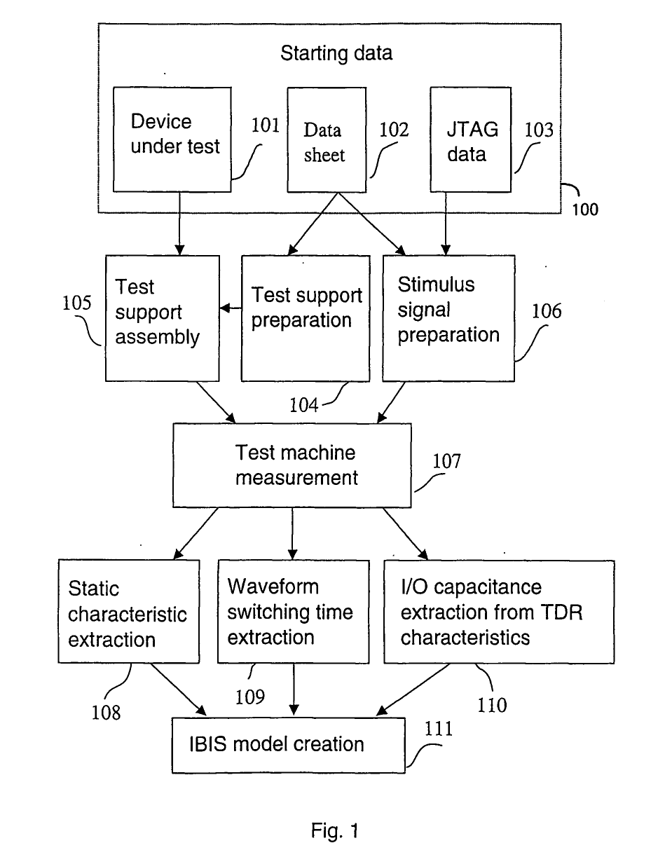

FIG. 1 is a flow chart illustrating a typical measurement session;

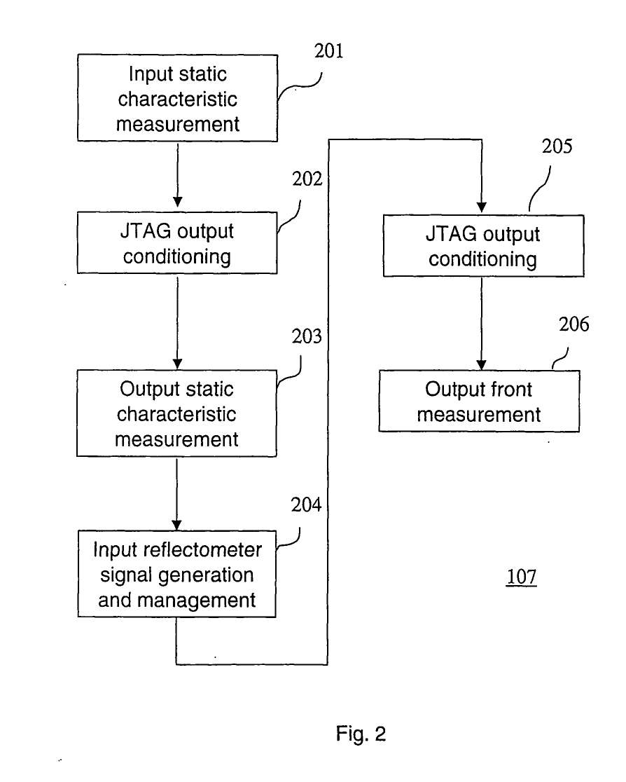

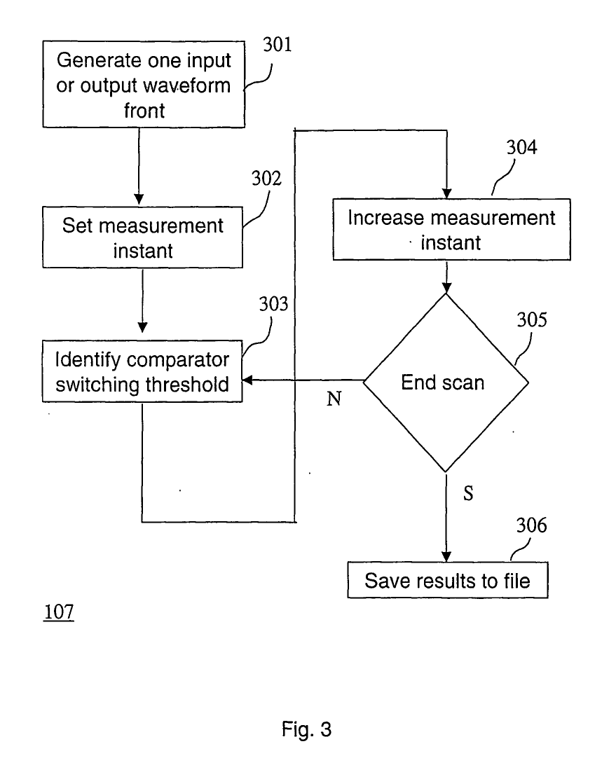

FIGS. 2 and 3 are flow charts illustrating the process for conducting the measurements by means of the test machine;

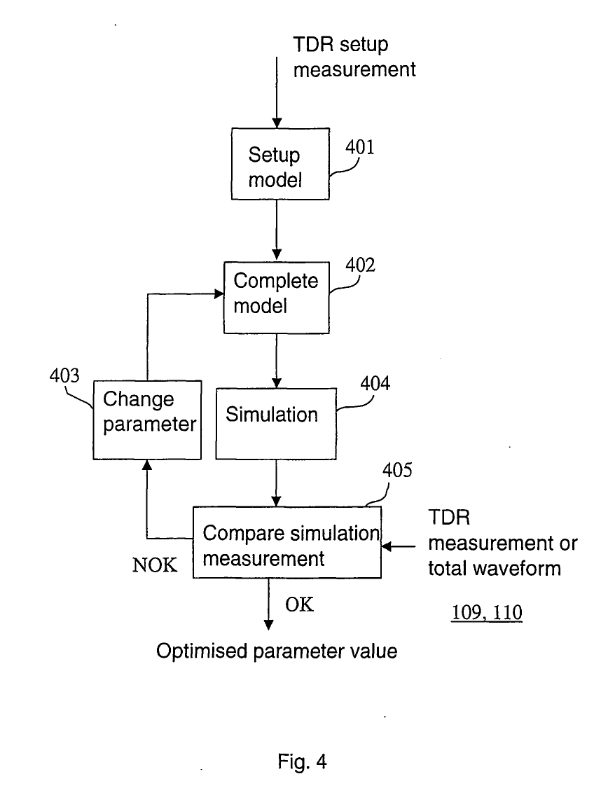

FIG. 4 is a flow chart illustrating the process which is used to extract the output switching time and the capacitance of the input or output ports of the component or system under test.

The process for the electromagnetic modelling of electronic components and systems employs a test machine of the commercial type, designed for conducting parametric measurements in direct current, functional tests and digital integrated circuit timing.

The characteristics required for the machine to be used in this process are:
the possibility of generating digital signals with sufficiently steep switching fronts, typically lower than 300 ps;
impedance controlled along all interconnections in the device under test;
possibility of monitoring all signals output by the device under test by sampling, with time resolution lower than 300 ps.

Various types of such machines are made by various manufacturers, e.g. the machine identified by code ITS9000 IX, made by Schlumberger.

In normal use for integrated circuit functional tests, signals with a suitable pattern are sent to the device inputs and the output signals are measured, checking that such signals are as required in a precise instant of the clock cycle.

The sampling method is used to measure the signals. Specifically, at input port level transition, the signal at the output port is compared with a pre-programmed reference threshold and the time instant in which the threshold was exceeded is recorded. By using a sufficiently high sampling frequency, the signal can be closely reconstructed. A subsequent study can be conducted to evaluate the response of the device, checking that the parametric, functional and timing characteristics, the output signal time delays and the input and output signal threshold values are within the tolerance range permitted in specifications.

The test machine according to this invention is used in a different way with respect to that described above: it is used as a time domain reflectometer, i.e. the test machine is used to send specific signals to the component ports and the reflections due to impedance offset are measured.

This method is not exploited in normal test machine use. Only in the initial machine channel calibration and characterisation phase, a signal is sent to the device support and the delay of the corresponding reflected signal is measured to determine the delay introduced by the device interconnection channel. The consequent compensations can be implemented, if required. However, the time pattern of the reflected signal is not studied in detail, to the extent that the integrated circuit under test is not present: in other words, the conditions are those of total reflection.

By extending the possibility of reconstructing signals, also to involve the signals reflected by the access ports of the device under test, the respective electric parameters can be obtained. These are essential for the electromagnetic modelling of the entire device according to the IBIS standard process mentioned above. In detail, the following parameters can be obtained:
the static voltage-current (V-I) characteristics at inputs and outputs;
the output switching times in the specific conditions of load;
the input and output capacitance;
the tripping times of the protection and clamp diode circuits, normally present in input ports;
various parasite parameters.

For the use according to this invention, the stimulus signals generated by the test machine must be sufficiently steep and present a sufficient amplitude, so as to allow high frequency measurements, preserving a good signal/noise ratio. For example, to measure the typical input capacitance of a digital integrated circuit, an amplitude of approximately 1 V is conveniently selected for obtaining a transition time of approximately 400 ps, which suitably adapts to the amplitude resolution of the test machine comparators. The signal offset can be set at a suitable level for the device, e.g. 2.5 V for an integrated circuit powered at 5 V.

Since impedance offset is measured, naturally the output impedance of the test machine must be controlled and fixed at a suitable value, e.g. 50 Ohms, as the impedance of all the interconnections between the generator and the access port of the device.

As mentioned above, the reflected signals are reconstructed using the periodical sampling method. The sampling input phase can be very finely tuned, e.g. with a resolution of 20 ps. After stablising the sampling phase, the comparison threshold is used to identify the internal comparator switching value, by using a suitable search algorithm, eg. dichotomy, linear etc., according to the morphology of the signal.

After reconstructing the pattern of the reflected signal, it is compared with the pattern obtained by simulating the measurement configuration in the time domain with a circuit simulator. The simulated model must include the same stimulus signal, the same impedance and the same interconnection channel delay and a variable load impedance, which is the unknown quantity to be determined. By varying the simulated impedance parameters (e.g. capacitance), various reflected signal patterns are obtained, given the same stimulus signal, to find the pattern which best reproduces the measured pattern by subsequent approximation. The value of the simulated impedance parameters thus corresponds to that associated to the device port.

Other parasite effects in the interconnection channel between generator and device, due to discontinuous impedance between support and connection cable, between support and device, etc., or loss due to skin effect in the cable and in the support, which are intrinsic to the test machine, can be accounted for in the model used for simulation and consequently compensated.

A similar process can be applied to the measurement of protection circuit and clamps on device access ports, by suitably arranging the voltage levels of the stimulus signal. For example, to characterise the protection circuit at input of an integrated circuit to the earth terminal, a stimulus signal passing from 0 V to −1 V and then from −1 V to 0 V can be used. By measuring the waveform reflected by the diode, which firstly conducts and then cuts off the stimulus signal, the characteristic transition time of the diode can be determined.

The subsequent approximation process herein described can also be applied to more conventional types of measurements, i.e. measurements based on the use of the test machine as a stimulus signal generator and respective output signal sampler, instead of as a time domain reflectometer. The component is programmed, by means of the test machine, so to generate repetitive output signals, which can be measured by means of the sampling procedure. The measured waveforms are not those of the component under test but those effected by the distortion introduced in the entire measurement system, consisting of the machine, the interconnections, the physical component support, etc. Consequently, a system model is required, for simulating the measurement providing the output waveform to be compared with those resulting from the measurements.

In this case, in the model used for the simulation, the unknown quantity to be identified consists of the intrinsic switching times of the device. A sequence of increasing switching times within a predefined range is set in the model for each output port so that the simulated waveform output by the measurement system model better approximates the measured waveform. The set switching time leading to the best approximation of the waveforms, is the unknown quantity sought.

The entire procedure, comprising the measurement phases, the simulation phases and the comparison phases, can be easily automated by implementing a specific test machine management and result processing application.

A typical measurement session according to the process of this invention is illustrated in the flow chart in FIG. 1.

Test device 101, with respective data sheet 102 and JTAG data 103, where relevant, form the starting data of phase 100. As known, JTAG is a standard according to which some component pins are dedicated to functional tests. For example, thanks to this standard, some parts of the device, deemed particularly critical, can be isolated and individually operated, during testing or trouble-shooting.

Consequently, the test support is prepared during phase 104. The test support is specific for the device under test and suitable to the test machine. The device is fitted in phase 105. According to the type of parameters to be extracted, suitable stimulus signals 106, to be used in the test machine in phase 107 for the measurements, must be prepared.

According to the resulting measurements, the device input and output voltage-current static characteristics are extracted in phase 108, the output switching times in certain conditions of load are extracted in phase 109, and the input or output port capacitance reactance is extracted in phase 110. Particularly, the switching time measurements are made according to the measured waveforms and the capacitance on the basis of reflected signals.

During the subsequent phase 111, the IBIS model containing all the measurement parameters is finally created.

The measurement process implementing the test machine, indicated with numeral 107, is illustrated in greater detail in FIGS. 2 and 3.

In FIG. 2, the various operations, indicated with numerals 201, . . . 206, consist in:
measuring the input static characteristics;
output conditioning by means of JOAG functions;
measuring output static characteristics;
generating and measuring input reflectometer signals;
output conditioning by means of JTAG functions;
measuring the output fronts.

The reflectometer and output waveform front measurement process is illustrated in FIG. 3.

In phase 301 “Generate one input or output waveform front”, the test machine controls the device under test. If measurements are carried out on the output signals, the machine programs the component to switch the outputs. In the next phase 302, the starting point of the switching front is established. This determines the start instant of the level measurement.

This measurement is conducted in phase 303, by comparing the signal with a variable threshold by means of a machine comparator to check correspondence of values. Consequently, the measurement instant is increased by one time unit defined in phase 304 and, if the measurement time window is not over because the switching transient is not complete, the cycle is repeated to measure the new signal level in phase 305. The succession of levels obtained, which reproduces the pattern of the waveform, is finally stored in a file during phase 306.

During reflectometer measurements, the output signal of the circuit under test is no longer considered in phase 301. In this case, the signal is reflected on an input port The process is similar and the result is the pattern of the reflected signal.

The process in which the output switching times and the input and output port capacitance, indicated with numerals 109 and 110, are extracted is illustrated in greater detail in FIG. 4.

In phase 410 “setup model”, an electric simulator model representing the measurement configuration is created, specifically including the interconnection cables with respective loss and impedance discontinuity, where relevant, the physical support and the stimulus signals. This model can be created on the basis of the reflectometer response obtained from the test machine in the configuration in which the support plate of the device under test is not inserted and is specific for each measurement channel available on the machine. Said responses contain all the information (characteristics impedance levels, propagation delay, etc.) required for the description by means of circuit simulation primitives.

The circuit model completed in phase 402 can be obtained by connecting the measurement system model to the device model containing one or more circuit parameters on circuit simulation level (for example capacitance, switching time, etc.) which value is to be extracted.

In phase 402, the model is updated with a first hypothesis of parameter, for example the switching time, which is then simulated in phase 404 and compared with the measurements provided by the test machine in phase 405. If the error exceeds a predefined threshold, the parameter is changed in phase 403 and the approximation cycle is repeated to obtain the minimal discrepancy between the measurement and the simulation. Finally, the resulting parameter is used for constructing the IBIS model.

The description herein is provided as a non-limiting example and obviously variations and changes are possible within the scope of protection of this invention.

1. Process for the electromagnetic modelling of electronic components and systems, in particular for the extraction of certain electrical parameters, such as the static V-I characteristics and the input and output impedance, the output switching times in particular conditions of load and the transition times of the protection diodes of said electronic components and systems, to ports of these components and systems suitable stimulus signals are sent and the correlated signals are measured, reconstructing the respective time patterns,
characterised in that a test machine of the commercial type is used for generating the stimulus signals and measuring the correlated signals, the test machine being suitable for parametric direct current measurements, functional tests and digital integrated circuit timing and also being used as a time domain reflectometer, in which case the test machine sends said stimulus signals to the component or system inputs or outputs, fitted on a suitable support and connected by means of suitable interconnection channels, and detects the reflection due to impedance offset, providing the respective time patterns, which are then compared with those provided by a simulated measurement system model, comprising the test machine signal generation and measurement part, the interconnection channels and the support, to verify the coincidence between the measure time pattern and that provided by the simulated model obtained by setting different values with respect to the electric parameters to be determined.

2. Process according to claim 1, characterised in that the model simulated by the measurement system is obtained by the reflectometer response of each channel of the test machine in the situation in which the support of the component or system is not connected to the machine.

3. Process according to claim 1, characterised in that the reflected signals are reconstructed by means of the periodical sampling method, by fine tuning the sampling pulse phase and operating on the comparison threshold of the measurement part of the test machine to identify the succession of values assumed in time by the reflected signal, so as to obtain the time pattern.

4. Process according to claim 1, characterised in that for measuring the electronic component and system input and output impedance, a variable load impedance is introduced in the simulated model, so as to obtain various patterns of the reflected signal, following the same stimulus signal, to find the pattern which best reproduces the measured pattern by subsequent approximation, the simulated impedance value corresponding to the impedance of the input or output to be determined.

5. Process according to claim 1, characterised in that for measuring the switching time of the outputs or transition time of the protection diode, a variable time is introduced in the simulated model, so as to obtain different patterns of the reflected signal, given the same stimulus signal, to find the pattern which best reproduces the measured pattern by subsequent approximation, the simulated switching or transition time corresponding to the value to be determined.
